(19) United States
(12) Patent Application Publication
(10) Pub. No.: US 2015/0370707 A1
(43) Pub. Date: Dec. 24, 2015

(54) DISUNITED SHARED-INFORMATION AND PRIVATE-INFORMATION CACHES

(71) Applicant: QUALCOMM Incorporated, San Diego, CA (US)

(72) Inventors: George PATSILARAS, Del Mar, CA (US); Bohuslav RYCHLIK, San Diego, CA (US); Anwar ROHILLAH, San Diego, CA (US)

(21) Appl. No.: 14/313,166

(22) Filed: Jun. 24, 2014

(51) Int. Cl. G06F 12/08; G06F 1/32

(52) U.S. Cl. CPC G06F 12/0811; G06F 12/084; G06F 1/3275; G06F 1/3287; G06F 2212/283; G06F 2212/314

(57) ABSTRACT

Systems and methods pertain to a multiprocessor system comprising disunited cache structures. A first private-information cache is coupled to a first processor of the multiprocessor system. The first private-information cache is configured to store information that is private to the first processor. A first shared-information cache which is disunited from the first private-information cache is also coupled to the first processor. The first shared-information cache is configured to store information that is shared/shareable between the first processor and one or more other processors of the multiprocessor system.

### FIELD OF DISCLOSURE

Disclosed aspects are directed to systems and methods for reducing access time and increasing energy efficiency of cache structures. More specifically, exemplary aspects are directed to separating cache structures, such as level 2 or level 3 caches in multiprocessor designs, such that disunited cache structures are provided for private-information and shared-information.

### BACKGROUND

Multiprocessor systems or multi-core processors are popular in high performance processing environments. Multiprocessor systems comprise multiple processors or processing cores (e.g., general purpose processors, central processing units (CPUs), digital signal processors (DSPs), etc) which cooperate in delivering high performance. To this end, two or more processors may share at least one memory structure, such as a main memory. Each of the processors may also have additional memory structures with varying degrees of exclusivity or private ownership. For example, a processor may have a level 1 (L1) cache which is a small, fast, high performance memory structure conventionally integrated in the processor's chip and exclusively used by, or private to, that processor. An L1 cache is conventionally used to store a small amount of important and most frequently used information by its associated processor. In between the L1 cache and the main memory, there may be one or more additional cache structures, conventionally laid out in a hierarchical manner. These may include, for example, a level 2 (L2) cache and sometimes, a level 3 (L3) cache. The L2 and L3 caches are conventionally larger, may be integrated off-chip with respect to one or more processors, and may store information that may be shared among the multiple processors. L2 caches are conventionally designed to be local to an associated processor, but contain information that is shared with other processors.

A notion of coherence or synchronization arises when L2 or L3 caches store information that is shared across processors. For example, two or more processors may retrieve the same information from main memory based on their individual processing needs and store the information in the shared L2 or L3 caches. However, when any updates are written back into the shared caches, different versions may get created, as each processor may have acted upon the shared information differently. In order to maintain processing integrity or coherence across the multiple processors, outdated information must not be retrieved from shared caches. Well known cache synchronization and coherency protocols are employed to ensure that modifications to shared information are effectively propagated across the multiple processors and memory structures. Such coherency protocols may involve hardware and associated software for each processor to broadcast updates to shared information, and “snoop” controllers and mechanisms to monitor the implementation and use of shared information.

For example, some implementations of coherency protocols involve tracking each entry or cache line of the shared caches. Coherency states, based for example on the well known modified/exclusive/shared/invalid (MESI) protocol need to be associated with each cache line of a shared cache. Any updates to these states must be propagated across the various memory structures and different processors. The snoop controllers cross check the coherency states of multiple copies of the same information across the various shared caches with a view to ensuring that the most up to date information is made available to any processor that requests the shared information. Implementations of these coherency protocols and snooping mechanisms are very expensive, and their complexity increases as the number of processors and shared cache structures increase.

However, a significant part of these expenses related to implementation of coherency protocols tends to be unnecessary and wasteful in conventional architectures. This is because a large part (as high as 80-90%) of a shared L2 cache, for example, is typically occupied by information that is not shared, or in other words, is private to a single associated processor. Such private information does not need expensive coherency mechanisms associated with it. Only the remaining, smaller fraction of the shared L2 cache, in this example, contains information that is likely to be shared across multiple processors, and would require coherency mechanisms. However, since the shared information, as well as, the private information are stored in a unified shared L2 cache, the entire shared L2 cache will need to have coherency mechanisms in place.

Moreover, the access times or access latencies are also needlessly high in conventional implementations. For example, a first processor wishing to access information private to the first processor but stored in a unified shared first L2 cache structure that is local to the first processor will have to search through both the private information as well as the shared information in order to access the desired private information. Searching through the shared first L2 cache conventionally involves tag structures, whose size and associated latency increase with the number of cache lines that must be searched. Thus, even if the first processor knows that the information that it is seeking to access is private, it must nevertheless sacrifice resources and access times to expand the search to the shared information stored in the shared first L2 cache. A similar problem also exists on the flip-side, for example, in the case of a remote second processor wishing to access shared information stored in the shared first L2 cache. The remote second processor would have to search through the entire shared first L2 cache, even though the shared information is contained in only a small portion of the shared first L2 cache.

Accordingly, there is a need to avoid the aforementioned drawbacks associated with conventional implementations of shared cache structures.

### SUMMARY

Exemplary embodiments of the invention are directed to disunited cache structures configured for storing private-information and shared-information.

For example, an exemplary embodiment is directed to a method of operating a multiprocessor system, the method comprising storing information that is private to a first processor in a first private-information cache coupled to the first processor, and storing information that is shared/shareable between the first processor and one or more other processors in a first shared-information cache coupled to the first processor. The first private-information cache and the first shared-information cache are disunited.

Another exemplary embodiment is directed to a multiprocessor system comprising: a first processor; a first private-information cache coupled to the first processor, the first private-information cache configured to store information that is private to the first processor, and a first shared-information cache coupled to the first processor, the first shared-information cache configured to store information that is shared/shareable between the first processor and one or more other processors. The first private-information cache and the first shared-information cache are disunited.

Another exemplary embodiment is directed to a multiprocessor system comprising: a first processor, first means for storing information that is private to the first processor, the first means coupled to the first processor, and second means for storing information that is shared/shareable between the first processor and one or more other processors, the second means coupled to the first processor. The first means and the second means are disunited.

Yet another exemplary embodiment is directed to a non-transitory computer-readable storage medium comprising code, which, when executed by a first processor of a multiprocessor system, causes the first processor to perform operations for storing information, the non-transitory computer-readable storage medium comprising: code for storing information that is private to the first processor in a private-information cache coupled to the first processor, and code for storing information that is shared/shareable between the first processor and one or more other processors in a first shared-information cache coupled to the first processor. The first private-information cache and the first shared-information cache are disunited.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a conventional multiprocessor system with conventional unified L2 caches.

FIG. 2 illustrates an exemplary multiprocessor system with exemplary disunited L2 caches, private-information L2 caches and shared-information L2 caches.

FIGS. 3A-B illustrate local and remote access times for exemplary disunited L2 caches when no hint is available.

FIGS. 4A-B illustrate local and remote access times for exemplary disunited L2 caches when a hint is available to indicate whether desired information is private or shared.

FIGS. 5A-C illustrate local and remote access times for parallel searches of exemplary disunited L2 caches.

FIG. 6 illustrates a flow-chart pertaining to an exemplary read operation and related coherency states of exemplary disunited caches.

FIGS. 7A-B illustrate a flow-chart pertaining to an exemplary write operation and related coherency states of exemplary disunited caches.

FIG. 8 is a flow-chart illustrating a method of operating a multiprocessor system according to exemplary aspects.

FIG. 9 illustrates an exemplary wireless device 900 in which an aspect of the disclosure may be advantageously employed.

### DETAILED DESCRIPTION

Aspects of the invention are disclosed in the following description and related drawings directed to specific embodiments of the invention. Alternative embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary aspects are directed to systems and methods for avoiding the wastage of resources and long access times associated with conventional unified shared cache structures which contain both private and shared information. Accordingly, one or more aspects are directed to disuniting or separating the shared information and private information and placing them in separate cache structures. In general, the term “information” as used herein, encompasses any type of information that can be stored in memory structures, such as a cache. More specifically, “information” can encompass instructions, as well as, data. Accordingly, exemplary aspects will be described for cache structures which can include instruction caches, data caches, or combined instruction and data caches. The distinction between instructions and data is not relevant to the exemplary aspects discussed herein, and thus, the term “information” is employed in the place of instructions and/or data, in order to remove confusions that may be generated by use of the term “data.” Accordingly, if an exemplary L2 cache is discussed with relation to exemplary aspects, it will be understood that the exemplary L2 cache can be a L2 instruction cache or a L2 data cache or a combined L2 cache which can hold instructions, as well as data. The more relevant distinction in exemplary aspects pertains to whether the information (instructions/data) in a cache is private or shared. Thus, references to “types of information” in this description pertain to whether the information is private or shared.

Accordingly, as employed herein, the term “private-information” is defined to include information that is not shared or shareable, but is private, for example, to a specific processor or core. On the other hand, information that is shared or shareable amongst several processors is defined as “shared-information.” One or more exemplary aspects are directed to disunited cache structures, where a private-information cache is configured to comprise private-information, whereas a shared-information cache is configured to comprise shared-information. Thus, a “conventional unified cache” which is defined to comprise private-information, as well as shared-information, is separated into two caches in exemplary aspects, where each cache is configured according to the type of information—a private-information cache and a shared-information cache. This allows optimizing each cache based on the type of information it holds.

In more detail, a first means such as a private-information cache is designed to hold information that is private to a local first processor or core associated with the private-information cache. A second means such as a shared-information cache is also provided alongside the private-information cache, which can hold information that is shared or shareable between the first processor and one or more other remote processors or remote caches which may be at remote locations with regard to the local first processor. This allows coherency protocols to be customized and implemented for the shared-information cache alone, as the private-information cache does not contain shared or shareable information, and thus does not require coherency mechanisms to be in place. Further, in reducing the cost of implementation of coherency protocols by limiting these to the shared-information cache, the exemplary aspects also enable faster access times and improve performance of a processing system employing the exemplary caches. In exemplary cases, the size of the private-information cache may be smaller than that of a conventional unified cache, and searching the private-information cache is faster because shared-information is excluded from the search. Even if the number of entries of the private-information cache is comparable or equal to the number of entries in a conventional unified cache, the exemplary private-information cache may be of smaller overall size and display improved access speeds because coherency bits and related coherency checks may be avoided in the exemplary private-information cache. In the example of shared-information, the coherency protocols may be tailored to the shared-information cache, which may be configured to hold a lower number of entries than a private-information cache or a unified conventional cache (e.g., based on empirical data). Based on the correspondingly smaller search space, access times for shared-information in the exemplary shared-information cache can be much faster than searching through a unified conventional cache for shared-information.

While the above examples have been provided with reference to relative sizes of exemplary private-information cache and shared-information cache, it will be understood that these examples are not to be construed as a limitation. On the other hand, exemplary aspects may include disunited private-information caches and shared-information caches of any size in terms of the number of cache entries stored in these caches. Improvements in performance and access speed may be observed in the exemplary disunited private-information caches and shared-information caches of any size, based on the avoidance of coherency implementation for private-information caches, and capability for directed search of information in the private-information cache or the shared-information cache. With this in mind, it will also be recognized that some aspects relate to exemplary cases where, based on empirical data related to the higher percentage of private-information in a cache which is local to a processor, the exemplary private-information cache may be made of larger size and an exemplary shared-information cache may be made of smaller size. Exemplary illustrations in the following figures may adopt such relatively larger sized private-information cache and smaller sized shared-information cache to show relative access speeds, but again, these illustrations are not to be construed as limitations.

It will also be recognized that aspects of exemplary aspects are distinguishable from known approaches which attempt to organize a conventional unified cache into a sections or segments based on whether information contained therein is private or shared, because, the search for information (and corresponding access times) are still high and correspond to search structures for the entire conventional unified cache. For example, merely identifying whether a cache line in a conventional unified cache pertains to shared or private information is insufficient to obtain the benefits of physically separate cache structures according to exemplary aspects.

It will be understood that the exemplary systems and methods pertain to any level or size of caches (e.g., L2, L3, etc.). While some aspects may be discussed with relation to shared L2 caches, it will be kept in mind that the disclosed techniques can be extended to any other level cache in a memory hierarchy, such as an L3 cache, which may include shared-information. Further, as previously noted, the exemplary techniques can be extended to instruction caches and/or data caches, or in other words, the information stored in the exemplary cache structures can be instructions and/or data, or for that matter, any other form of information which may be stored in particular cache implementations.

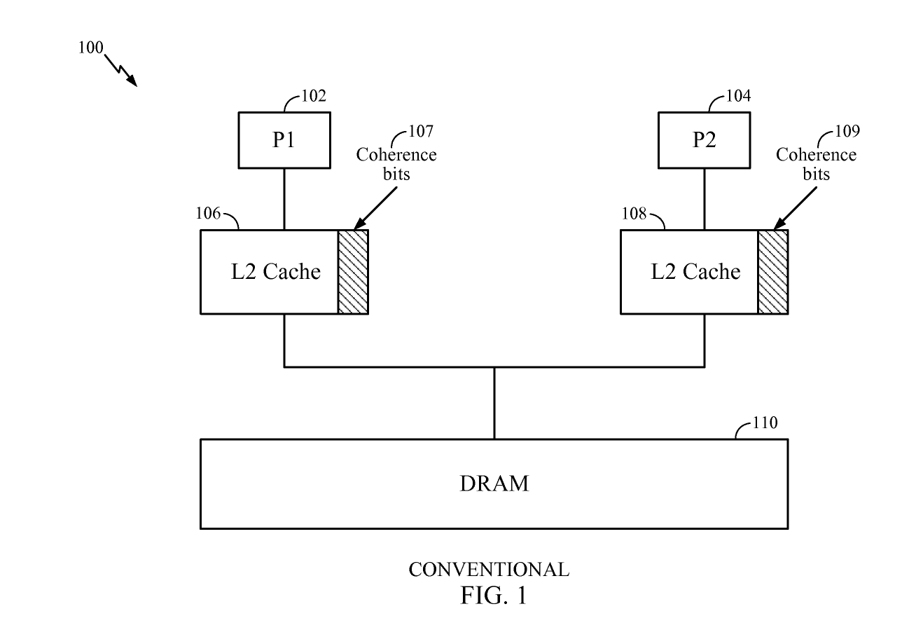

With reference now to FIG. 1, a conventional multiprocessor system 100 is illustrated. First and second processors 102 and 104 are shown to have associated L2 caches 106 and 108, which are communicatively coupled to main memory 110. In the following description, first processor 102 may be considered a local processor in relation to which, second processor 104 may be a remote processor, or located at a remote location. The terms “local” and “remote” are merely for conveying relative placements of caches and other system components in this discussion, and are not to be construed as a limitation. Further, there is no requirement herein, for a remote location to be off-chip or on a different chip from that on which a local processor is integrated, for example. For the sake of simplicity, other caches (e.g., local L1 caches within processors 102, 104, L3 cache, etc.) are omitted from this illustration, but may be present. L2 caches 106 and 108 may be shared between processors 102 and 104. L2 caches 106 and 108 are conventional unified caches and they contain both private and shared information. For example, L2 cache 106 is local with respect to processor 102 and contains information that is private to local processor 102 (i.e., “private-information,” herein), as well as, information that is shared with remote processor 104 (i.e., “shared-information,” herein). Since L2 cache 106 is a conventional unified cache, all entries or cache lines of L2 cache 106 must implement coherency protocols. This is representatively illustrated by coherence bits 107 spanning all rows of L2 cache 106. Similarly, coherence bits 109 for L2 cache 108 are also shown. L2 caches 106 and 108 suffer from aforementioned drawbacks associated with unnecessary implementation of coherency protocols for private-information, long access times, high power consumption, inefficient searching functions, wasted resources, etc.

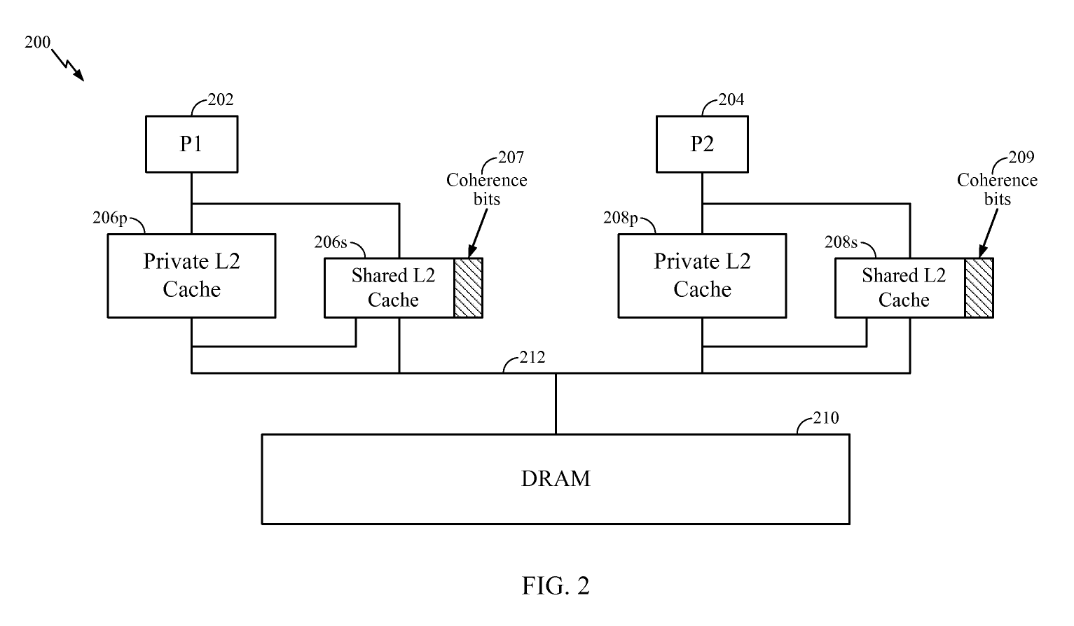

With reference now to FIG. 2, an exemplary aspect is illustrated with regard to multiprocessor system 200 comprising processors 202 and 204. In contrast to conventional multiprocessor system 100 of FIG. 1, multiprocessor system 200 includes disunited caches communicatively coupled to main memory 210, with system bus 212 handling various interconnections thereof (for the sake of simplicity, additional details, such as L1/L3 caches, etc., are omitted in this view, with the understanding that these and other aspects of memory hierarchy may exist, without limitation). In more detail, L2 cache 106 of multiprocessor system 100, for example, is replaced by disunited caches, private-information L2 cache 206p and shared-information L2 cache 206s. Private-information L2 cache 206p includes private-information that is private (i.e., not shared or shareable) to processor 202, where processor 202 is local with respect to private-information L2 cache 206p. Shared-information L2 cache 206s includes shared-information which may be shared or shareable with local processor 202 and remote processor 204.

In some aspects, for example, as illustrated, private-information L2 cache 206p may be larger in size, as compared to shared-information L2 cache 206s. However, as already discussed, this is not a limitation, and it is possible that private-information L2 cache 206p may be of smaller or equal size as compared to shared-information L2 cache 206s in other aspects, based for example, on the relative amounts of private and shared information that are accessed from these caches by processor 202, or performance requirements desired for private-information and shared-information transactions. In some cases, the combined amount of information (private or shared) which can be stored in private-information L2 cache 206p and shared-information L2 cache 206s can be comparable to the amount of information that may be stored in conventional unified L2 cache 106 of multiprocessor system 100. Thus, in an illustrative example, the size of private-information L2 cache 206p may be 80-90% of that of conventional unified L2 cache 106, whereas, the size of shared-information L2 cache 206s may be 10-20% of that of conventional unified L2 cache 106. Once again, such cases are also not a limitation, and the combined amount of information may be less than or larger than, for example, the number of entries in a conventional unified cache such as, conventional L2 cache 106 of FIG. 1. Even in cases where the combined size of exemplary private-information L2 cache 206p and shared-information L2 cache 206s may be greater than, say, conventional L2 cache 106, access times in exemplary aspects may still be faster because hints (as will be discussed further below) may be provided to direct search for particular information to one of private-information L2 cache 206p or shared-information L2 cache 206s; or private-information L2 cache 206p and shared-information L2 cache 206s may be searched in parallel (also, as will be further discussed in following sections).

With continuing reference to FIG. 2, coherence bits 207 are associated only with shared-information L2 cache 206s, while private-information L2 cache 206p is not shown to have corresponding coherence bits. In comparison to coherence bits 107 of conventional unified L2 cache 106, the size of coherence bits 207 can be smaller, in the sense that they are only required for entries stored in the smaller shared-information L2 cache 206s. Additional details regarding coherency protocols, as applicable to exemplary aspects, will be covered in later sections of this disclosure. Shared-information L2 cache 206s can function as a snoop filter for the larger private-information L2 cache 206p, in the sense that remote processor can first search or snoop shared-information L2 cache 206s, and in rare cases, may extend the search to private-information L2 cache 206p (which, as discussed above, may include some shared or shareable information).

With the above general structure of disunited exemplary caches, populating and accessing private-information L2 cache 206p and shared-information L2 cache 206s will now be discussed. It will be understood that corresponding aspects related to private-information L2 cache 208p and shared-information L2 cache 208s with coherence bits 209 is similar, and a detailed discussion of these aspects will not be repeated, for the sake of brevity. It will also be understood that processors 202 and 204 may be dissimilar, for example, in heterogeneous multiprocessor systems, and as such, features of the disunited caches of each processor may be different. For example, the sizes of the two private-information L2 caches, 206p and 208p may be different and independent, and the sizes of the two shared-information L2 caches, 206s and 208p may be different and independent. Correspondingly, their access times and access protocols may also be different and independent. Accordingly, exemplary protocols will be described for determining whether a particular cache line or information must be directed to private-information L2 cache 206p and shared-information L2 cache 206s for population of these caches; the order in which these disunited caches can be searched for accessing particular cache lines in the case of sequential search of these exemplary caches; options for parallel searches of the exemplary caches; and comparative performance and power benefits. In general, it will be recognized that the disunited caches can be selectively disabled for conserving power. For example, if processor 202 wishes to access private information, and the related access request is recognized as one that should be directed to private-information L2 cache 206p, then there is no reason to activate, or keep active, shared-information L2 cache 206s. Thus, shared-information L2 cache 206s can be deactivated or placed in a sleep mode.

Accordingly, an exemplary aspect may pertain to exemplary access of disunited caches where no additional hint or indication is available regarding whether the desired access is for private-information or shared-information. For example, processor 202 may wish to access information from its local L2 cache, but it may not know whether this information will be located in private-information L2 cache 206p or shared-information L2 cache 206s. Therefore, both private-information L2 cache 206p and shared-information L2 cache 206s may need to be searched. In one aspect, private-information L2 cache 206p and shared-information L2 cache 206s may be searched sequentially (parallel search is also possible, and will be discussed in further detail below). The order of the sequential search may be tailored to particular processing needs, and while the case of searching private-information L2 cache 206p first and then shared-information L2 cache 206s will be accorded a more detailed treatment, the converse case of searching shared-information L2 cache 206s first and then private-information L2 cache 206p can be easily understood from the description herein. The sequential search can be conducted based on an exemplary protocol which will optimize the access times in most cases by recognizing the most likely one of the two disunited caches where the desired information will be found, and searching that most likely one of the two disunited caches first. In a few rare cases, the sequential search will need to extend to the less likely one of the two disunited caches after missing in the more likely one. While it is possible that in these rare cases, the overall access may be higher than that of searching through a conventional unified cache, the overall performance of the exemplary multiprocessor system 200 is still higher than that of conventional multiprocessor system 100 because the common case is improved. While parallel searching is also possible, this would entail activating both private-information L2 cache 206p and shared-information L2 cache 206s and related search functionality. Accordingly, parallel searches may involve a tradeoff between power savings and high speed access in some aspects.

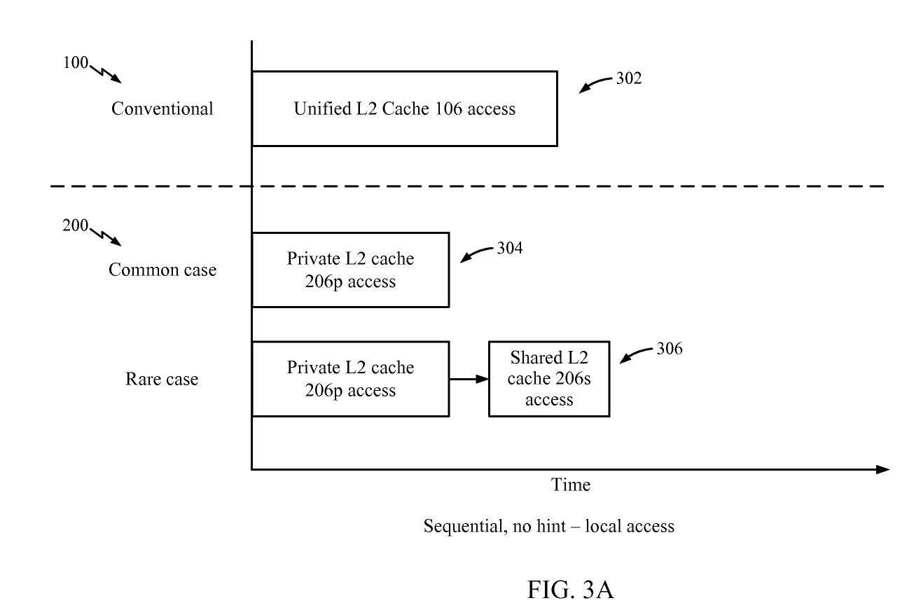

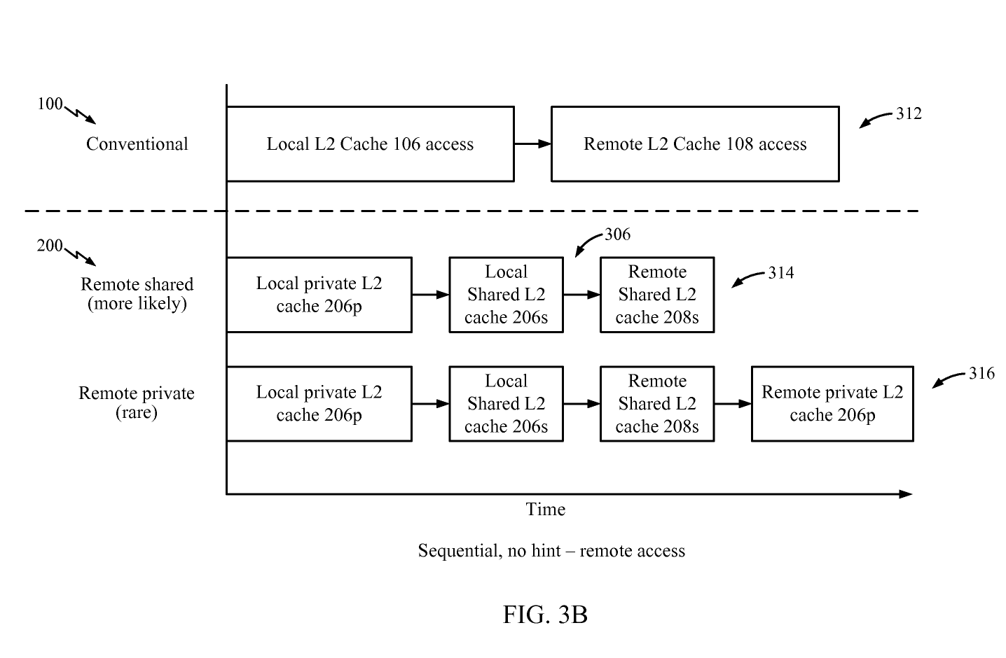

The above aspects related to local access are pictorially represented in FIG. 3A. The time taken to access the conventional unified L2 cache 106 of conventional multiprocessor system 100 is illustrated as time 302. Coming now to exemplary multiprocessor system 200, in the common case scenario, processor 202 will assume that the desired information is private (as previously discussed, this conventionally makes up about 80-90% of accesses). Therefore, processor 202 may first search private-information L2 cache 206p. The time taken to access private-information L2 cache 206p is illustrated as time 304. Representatively, time 304 is shown to be smaller than time 302, and thus, in the common case, exemplary aspects can reduce the access times. In the rare cases, the desired information is not private, but is shared or shareable with remote processor 204 (this conventionally makes up about 10-20% of accesses). Therefore, in these cases, once processor 202 has searched through private-information L2 cache 206p and missed, processor 202 may sequentially proceed to search shared-information L2 cache 206s. The overall access time for this sequential search is illustrated as time 306. As seen, time 306 may be slightly larger than the conventional unified L2 cache 106 access time 302. However, since the rare case is infrequent, the overall performance of exemplary multiprocessor system 200 is improved due to the improvement of the common case accesses.

Additionally, exemplary aspects can further optimize the common cases for sequential search by placing the cache to be searched first physically close to the processor. For example, in the above-described exemplary aspect, by placing private-information L2 cache 206p physically close to processor 202 wire delays may be reduced. Since private-information L2 cache 206p does not need coherency state tags, the size of private-information L2 cache 206p can be further reduced by customizing the design of private-information L2 cache 206p to omit coherency-related hardware which is conventionally included in an L2 cache. Further, since snoop requests from remote processor 204 do not interfere with local processor 202's private access to private-information L2 cache 206p, the private accesses are further optimized.

Coming now to the case where the desired information is not found in shared-information L2 cache 206s either, after time 306, processor 202 may extend the search to remote processor 204's shared-information L2 cache 208s and private-information L2 cache 208p. These cases fall under the category of remote access. The access times for such remote accesses are also improved in most cases in exemplary aspects. The remote accesses and corresponding access times will be discussed in relation to comparable remote accesses in conventional multiprocessor system 100, with reference to FIG. 3B.

Referring to FIG. 3B, remote access protocols and access times are illustrated with regard to the above-described sequential search in FIG. 3A. In conventional multiprocessor system 100, if it is determined that unified local L2 cache 106 does not have the information desired by processor 102, then processor 102 may check remote L2 cache 108. The access times to search through both L2 caches 106 and 108 are cumulative, and represented by time 312. In exemplary multiprocessor system 200, on the other hand, by time 306 (see FIG. 3A), it will be determined that both local caches, private-information L2 cache 206p and shared-information L2 cache 206s do not have the information desired by processor 202. Processor 202 then proceeds to first check remote shared-information L2 cache 208s, as this is more likely (once again, 80-90% of remote accesses) to have shared information. Thus, in the more likely scenario, the cumulative time required for sequential access of local caches, private-information L2 cache 206p, shared-information L2 cache 206s, and then remote shared-information L2 cache 208s is time 314. As seen, time 314 is less than time 312 for conventional implementations. In rare cases (e.g. 10-20% of remote accesses), the shared information may end up being present in remote private-information L2 cache 208p, and sequential access would incur access time 316, which may be slightly more than the conventional access time 312. However, the performance benefits of superior access times in the more likely scenarios outweigh the performance impacts by longer access time in the rare cases. Moreover, in some implementations, if the shared information is found in the remote private-information L2 cache 208p, then it can be promoted to remote shared-information L2 cache 208s for reducing corresponding access times in future. Once again, it will be noted that the order of sequential search of remote caches can be reversed, if desired, by first searching remote private-information L2 cache 208p and then remote shared-information L2 cache 208s. Moreover, in other cases, the searches of the remote caches may also be in parallel.

Some exemplary aspects may also include hardware/software optimizations to further improve remote accesses. For example, with regard to illustrated aspects in FIG. 3B, and with reference to FIG. 2, remote shared-information L2 cache 208s may be placed close to system bus 212 for shorter wire delays during remote accesses. Also, as previously described the area of remote shared-information L2 cache 208s can be made smaller than remote private-information L2 cache 208p, and coherence bits 209 and associated hardware may be limited to remote shared-information L2 cache 208s. Remote shared-information L2 cache 208s also acts as a snoop filter for remote private-information L2 cache 208p, and interference from a vast majority of local accesses from processor 204 are avoided to shared-information L2 cache 208s (as local accesses from processor 204 are more likely to hit in private-information L2 cache 208p).

While the above exemplary aspects pertaining to sequential local and remote accesses have been described for cases when no hints are available for determining beforehand whether the information desired is private or shared/shareable, one or more aspects can also include hints to guide this determination. For example, using compiler or operation system (OS) support, particular information desired by a processor can be identified as private to the processor or shared/shareable with remote processors. In other examples pertaining to known architectures, page table attributes or shareability attributes such as “shared normal memory attribute” are employed to describe whether a memory region is accessed by multiple processors. If the desired information belongs to that memory region, then that information can be identified as shared or shareable, and hence, not private. Such identification about the type of the information can be used for deriving hints, where the hints can be used for directing access protocols.

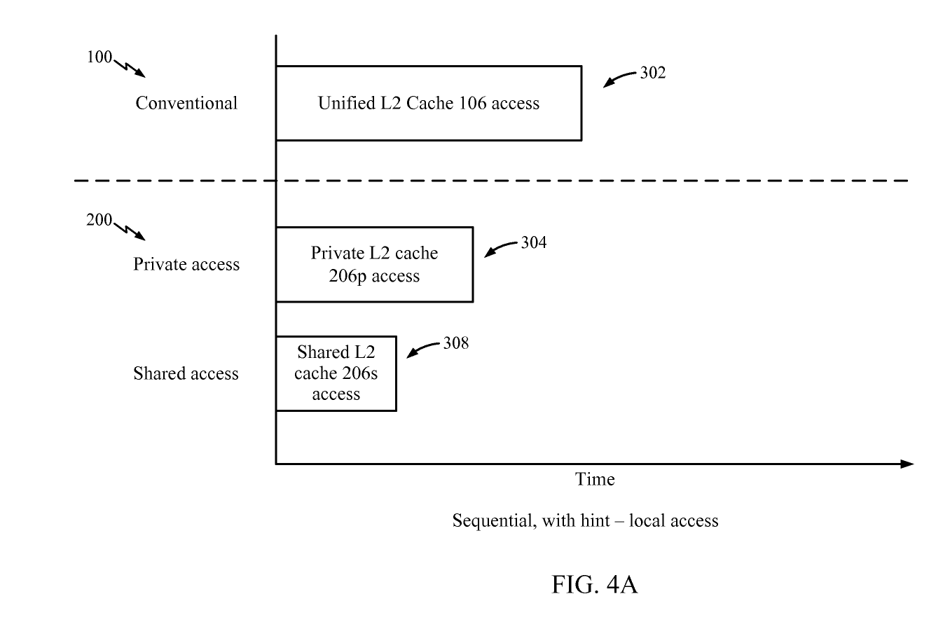

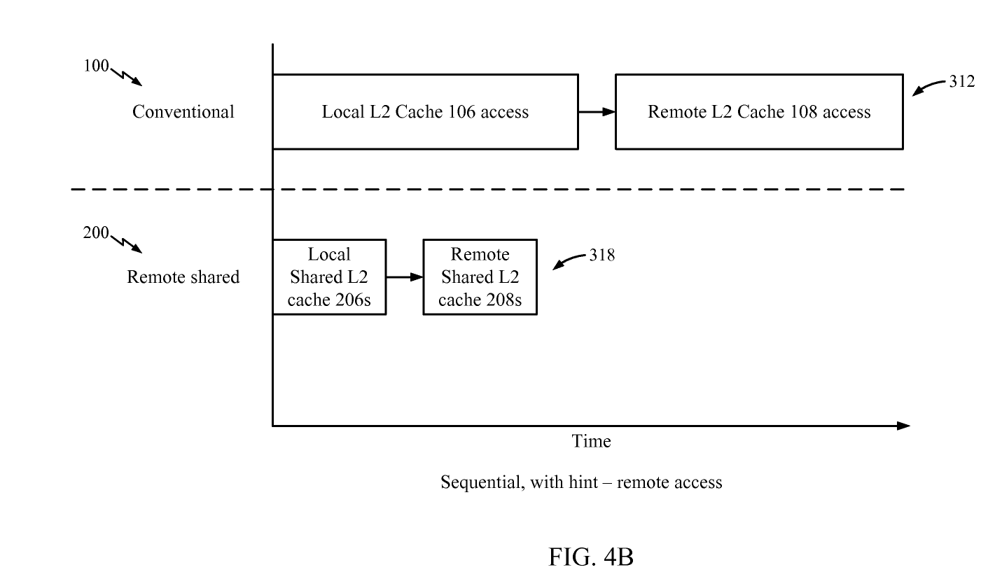

For example, if processor 202 knows whether the information that it is seeking to access is private or shared/shareable, based on a hint, then it may directly target the cache that would hold the type of the information. More specifically, if the information is determined to be private, based on a hint, then processor 202 may direct the related access to private-information L2 cache 206p, with the associated low latency. For example, with reference to FIG. 4A, for local accesses, if a hint is available, then for private information, the access time would correspond to time 304 for accessing private-information L2 cache 206p (similar to the common case scenario described with reference to FIG. 3A, when no hint is available). For shared information, the access time would correspond to the access time for the small shared-information L2 cache 206s, or time 308. Both of these access times 304 and 308 are seen to be lower than the corresponding conventional access time of unified L2 cache 106, which would still be time 302, as hints will not speed up conventional access times.

With reference to FIG. 4B, remote accesses and associated access times are illustrated, where hints are available. For shared-information (based on a hint), if the desired information by processor 202 encounters a miss in local shared-information L2 cache 206s, then it proceeds to access remote shared-information L2 cache 208s. The cumulative access time would be time 318. Once again, it is noted that time 318 is significantly lower than the corresponding time 312 incurred in conventional implementations, as discussed in relation to FIG. 3B, as hints do not speed up access times in conventional implementations.

It will be understood that if information that is known to be private, based on the hint, misses in local private-information L2 cache 206p, then the access protocols would not proceed to search the remote caches, because the information is private, and hence, would not be present in any other remote cache. Thus, pursuant to the miss, the access protocols would directly proceed to search the next level of memory (such as an L3 cache in some cases, or main memory 210). This manner of directly proceeding to search higher level caches and/or main memory conforms with expected behavior where, following a context switch or thread migration, all data in private caches would be written back (if dirty) and invalidated.

Additional optimizations pertaining to power considerations can also be included in some exemplary aspects. For example, for multiprocessors with two or more processors or cores, not all information is shared across all active processors, and with increasing number of processors, looking up all processors' remote private-information caches and remote shared-information caches tends to be very expensive and power consuming. In order to handle this efficiently in a low cost/low power manner, some exemplary aspects implement a hierarchical search for information, where the hierarchical search is optimized for the common case for the shared-information. When a requesting processor searches other remote processors for the desired information, the requesting processor may first send a request for the desired information to all the remote shared-information caches. If the desired information misses in all the shared-information caches, a message may be sent back to the requesting processor informing the requesting processor about the miss. Exemplary aspects may be configured to enable extending the search to the remote private-information caches only if the desired information misses in all of the shared-information caches. Thus, sequential searches according to exemplary aspects described above can be extended to any number of processors, for example, in cases where no hints are available.

Accordingly, exemplary multiprocessor systems can advantageously disunite a cache structure into a private-information cache and a shared-information cache. These two disunited caches can be customized for their particular purposes. For example, the private-information cache can be optimized to provide a high performance and low power path to an associated local processor's L1 cache and/or processing core. The shared-information cache can be optimized to provide a high performance and low power path to the rest of the exemplary multiprocessor system. Since the private-information cache is no longer required to track coherence, the shared-information cache can be further optimized in this regard. For example, more complex protocols can be employed for tracking coherence, since the overhead of implementing these complex protocols would be lower for the small disunited shared-information cache than for a comparatively larger conventional unified cache.

Moreover, the relative sizes and number of cache lines of the private-information cache and the shared-information cache can be customized based on performance objectives. Associativity of the shared-information cache can be tailored to suit sharing patterns or shared-information patterns, where this associativity can be different from that of the corresponding private-information cache. Similarly, replacement policies (e.g., least recently used, most recently used, random, etc) can be individually selected for the private-information cache and the shared-information cache. The layouts for the private-information cache and the shared-information cache can also be customized, for example, since the layout of the private-information cache with a lower number of ports (owing to the coherence states and messages being omitted) can be made to differ from that of the shared-information cache. Power savings can be obtained, as previously discussed, by selectively turning off at least one of the private-information cache and the shared-information cache during a sequential search. In some cases, the private-information cache can be turned off when its associated processor is not executing code, as this would mean that no private-information access would be forthcoming.

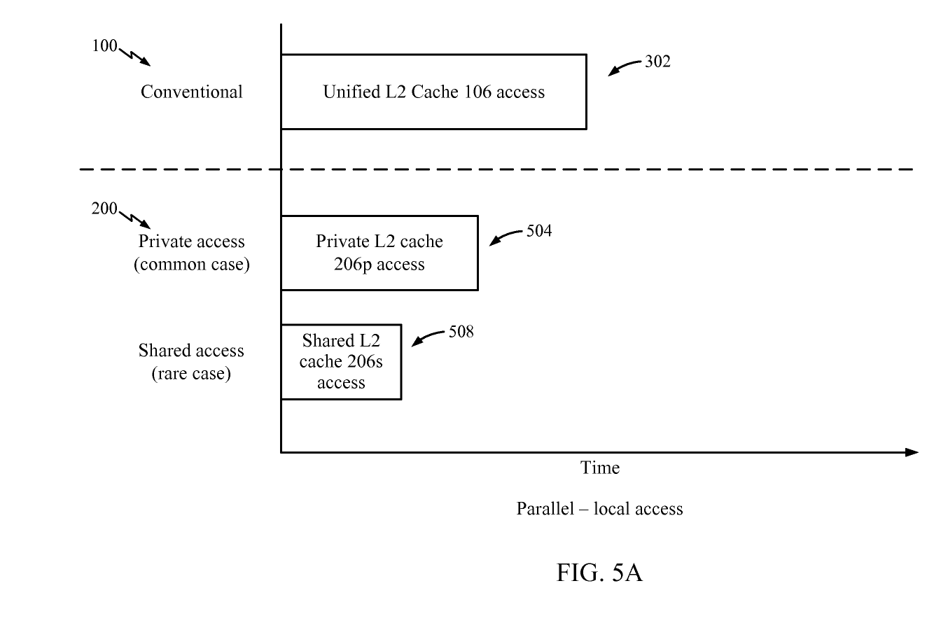

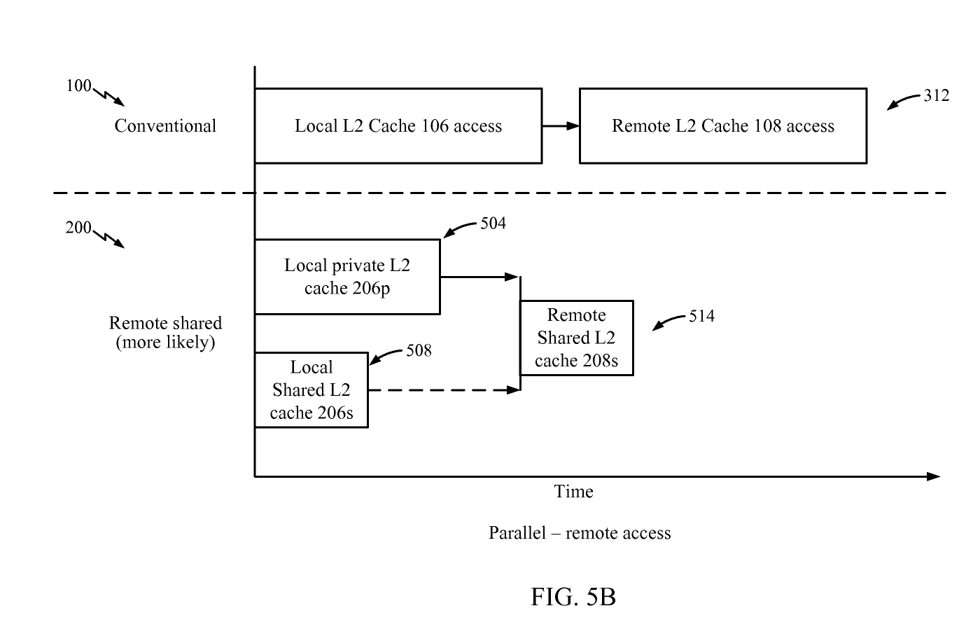

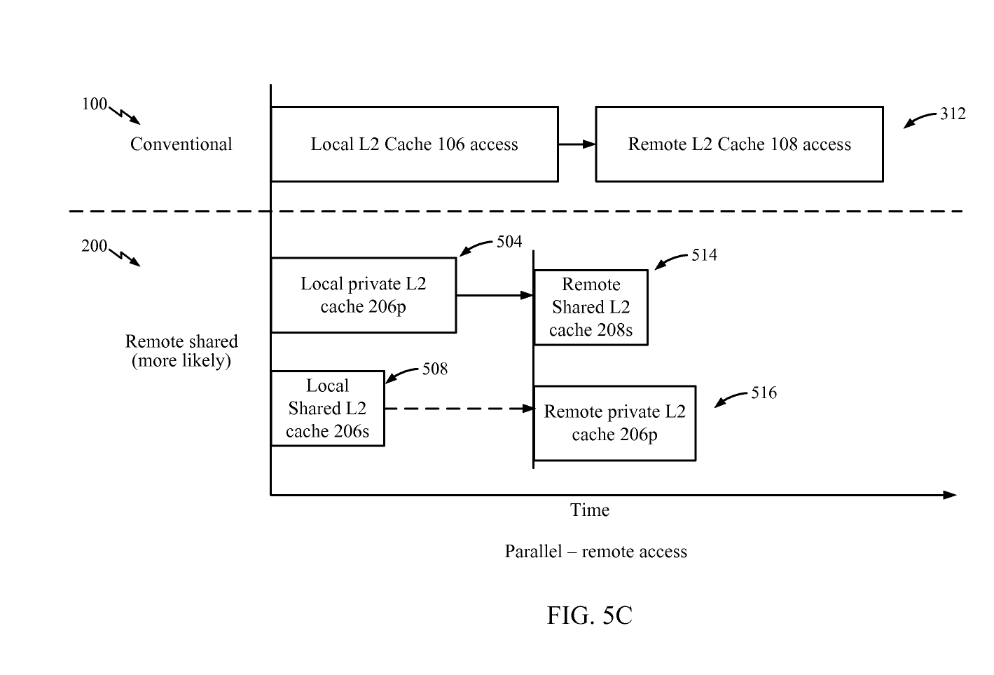

With reference now to FIGS. 5A-C, parallel access of the exemplary private-information and shared-information caches will be discussed. In general, these cases may relate to situations where a hint is unavailable, because a hint would facilitate directed search only to the cache which is more likely to have the desired information. However, this is not a limitation, and if desired, parallel search may also be performed if a hint is available.

Referring to FIG. 5A, the illustrations therein once again illustrate the access time for conventional unified L2 cache 106 as access time 302. In comparison, access times for private-information L2 cache 206p is shown as access time 504, while access time for shared-information L2 cache 206s is shown as access time 508, where accesses related to access times 504 and 508 occur in parallel. Accordingly, the overall latency or access time for searching through both private-information L2 cache 206p and shared-information L2 cache 206s in parallel will be the longer of access times 504 and 508. In the illustrated case, private-information L2 cache 206p is assumed to be larger, with a correspondingly higher access time 504, and thus the parallel search will consume a latency related to access time 504 (even if the access times 504 and 508 were equal, based on private-information L2 cache 206p and shared-information L2 cache 206s being of the same size, the higher one of the access times would still be equal to 504, or 508, and thus, the treatment of this case will be similar). As can be seen, this is lower than access time 302. While such parallel access in exemplary aspects may require both private-information L2 cache 206p and shared-information L2 cache 206s to be powered on and searched, incurring some redundancy, the performance benefits may outweigh the added costs in power, because information can be returned from the cache in which the information is present sooner than it would be possible with a unified conventional cache.

With reference to FIG. 5B, the scenario is illustrated where both private-information L2 cache 206p and shared-information L2 cache 206s do not contain the desired information, for example, as it relates to FIG. 5A. Thus, remote access must be initiated. In a conventional unified cache implementation, the overall access times for the remote access would be the cumulative access times along with any additional latencies involved in searching through unified local L2 cache 106 and then remote L2 cache 108, depicted as access time 312. On the other hand, once the parallel search of private-information L2 cache 206p and shared-information L2 cache 206s is concluded at the greater of access times 504 and 508 (which as illustrated is 504), the remote search can be immediately commenced, i.e., earlier than possible for the conventional unified L2 caches. Remote shared-information L2 cache 208s can then be searched for the desired information, as this is where shared information is most likely to be present. If the desired information is present in remote shared-information L2 cache 208s, the access time will be as denoted by access time 514, which is lower than access time 312.

With reference to FIG. 5C, an alternative aspect to FIG. 5B is illustrated, where the remote search of exemplary disunited caches may also be performed in parallel, rather than first searching through remote shared-information L2 cache 208s, as in FIG. 5B. As such, in FIG. 5C, remote shared-information L2 cache 208s and remote private-information L2 cache 208p are also searched in parallel, with overall latencies, 514 and 516, as depicted. Overall latency 516 is greater in this example, based on the assumption that remote private-information L2 cache 208p is larger. Overall latency 516 relates to the time taken to search the local disunited caches in parallel, and then search the remote disunited caches in parallel. As seen, overall latency 516 is lower than latency 312 for the conventional unified local and remote L2 caches. Thus, once again, even in the less common example depicted in FIG. 5C, the performance and access times are improved, and may offset any added costs in power incurred.

From the above-described exemplary aspects, it can be seen that it may be desirable to configure the exemplary private-information and shared-information caches to be disunited. Moreover, in some aspects, it may be desirable to configure the disunited private-information and shared-information caches such that shared-information is disallowed from being populated in the private-information cache and private-information is disallowed from being populated in the shared-information cache. In this way, it may be possible to customize the size, coherency mechanisms, placement, etc., of the disunited caches based on the nature of information stored therein.

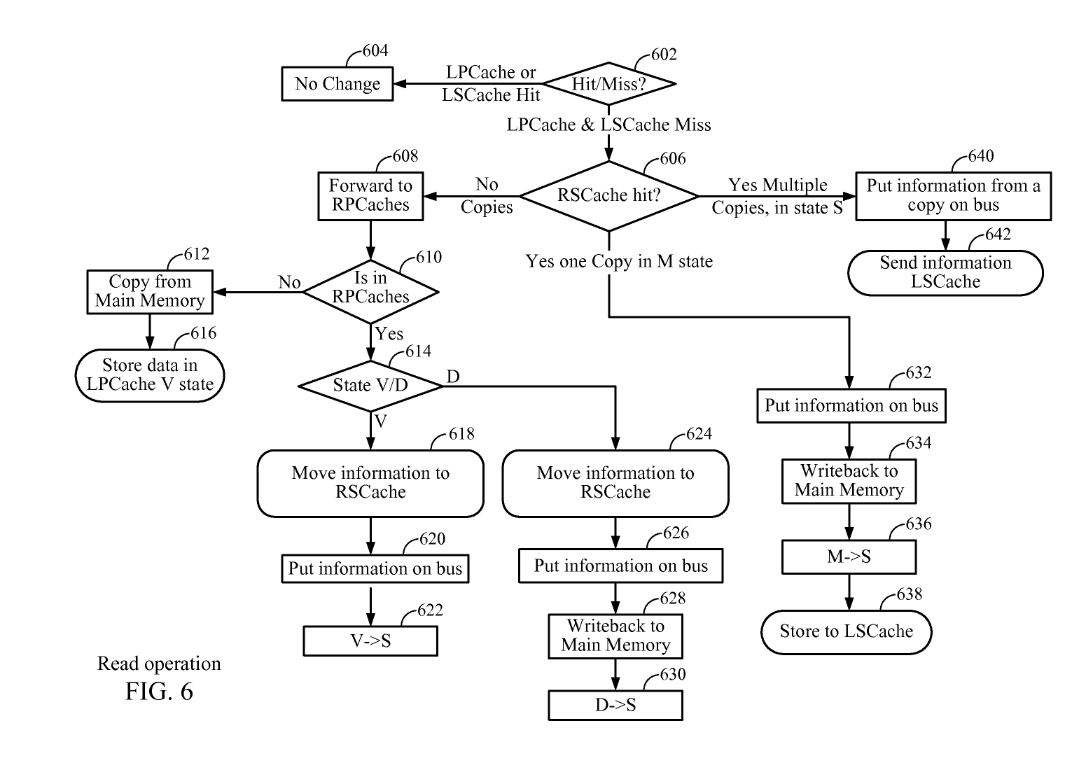

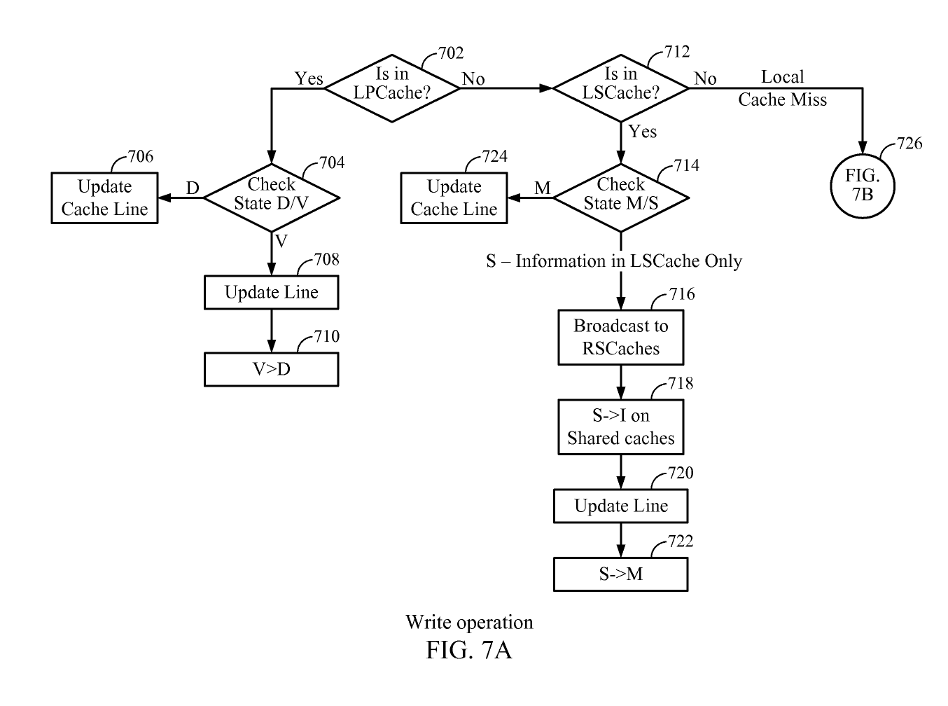

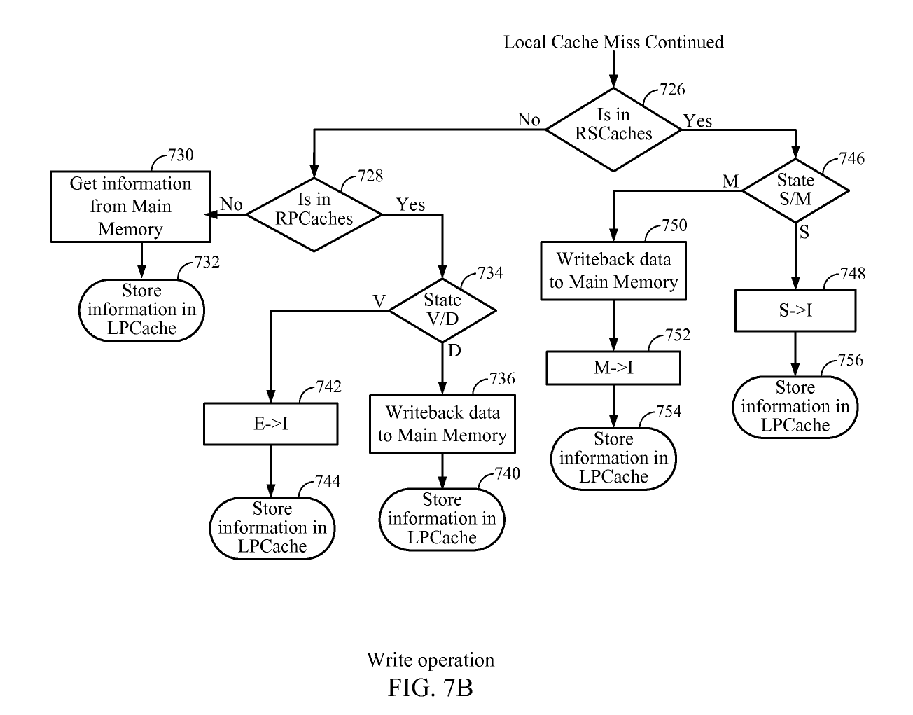

With reference now to FIGS. 6-7, implementations of coherency protocols in exemplary aspects, for read and write operations respectively, are illustrated. A commonly used mechanism to maintain coherence particularly in write-back caches involves the so called MESI protocol, as previously mentioned. Briefly, the conventional MESI protocol defines the four states: Modified (M), Exclusive (E), Shared (S), and Invalid (I), for every cache line or cache entry of a first cache, for example, within a multiprocessor system with shared memory. The Modified (M) state indicates that the cache entry is present only in the first cache, but it is “dirty,” i.e. it has been modified from the value in main memory. The Exclusive (E) state indicates that only the first cache possesses the cache entry, and it is “clean,” i.e. it matches the value in main memory. The Shared (S) state indicates that the cache entry is clean, but copies of the cache entry may also be present in one or more other caches in the memory system. The Invalid (I) state indicates that the cache entry is invalid. Coherency is maintained by communication between the various processing elements (also known as “snooping”) related to desired memory accesses, and managing permissions for updates to caches and main memory based on the state (M/E/S/I) of the cache entries. For example, if a first processor in the multiprocessor system desires to write data to a cache entry of the first cache, which may be a local L1 cache associated with the first processor, then if the cache entry is in exclusive (E) state, the first processor may write the cache line and update it to a Modified (M) state. On the other hand, if the cache entry is in a Shared (S) state, then all other copies of the cache entry must be invalidated before the first processor may be permitted to write the cache entry. Exemplary implementations of coherency protocols can be tailored to exemplary disunited local and remote caches, as discussed herein.

FIGS. 6-7 may be applicable to any processing system, such as, multiprocessor system 200 of FIG. 2. FIGS. 6-7 relate to operational flow for read (load) and write (store) operations following a corresponding request by an originating local processor. One or more remote processors may exist with corresponding caches. For the sake of generality, the local disunited caches of the requesting local processor (e.g., private-information L2 cache 206p and shared-information cache L2 cache 206s of local processor 202 of processing system 200) have been denoted as “LPCache” and “LSCache” respectively in FIGS. 6-7. As such, LPCache and LSCache may be any local private-information and shared-information caches, including L2 caches, L3 caches, or the like. Similarly, remote disunited caches of remote processors (e.g., remote private-information L2 cache 208p and shared-information cache L2 cache 208s of remote processor 204) have been generally denoted as “RPCache,” and “RSCache,” respectively. Any number of such remote processors and corresponding remote caches, RPCaches and RSCaches, may exist in the context of FIGS. 6-7. In the case of private-information caches (e.g., LPCaches and RPCaches), it will be recalled that notions of coherency do not arise, and therefore, the above-described Exclusive (E) state for a cache entry of a private-information cache would relate to a “Valid” bit being set or being in a “V” state for the cache entry. Similarly, the Modified (M) state would pertain to a “Dirty” bit being set or being in a “D” state for the cache entry.

With the above notations in mind, FIG. 6 illustrates a flow-chart pertaining to a read or load operation in an exemplary multiprocessor system, where the read operation involves searching for copies of information by a requesting local processor. In decision block 602, the read operation commences by searching for the desired information in the local disunited caches, LSCache and LPCache (whether this is performed sequentially, without, or with a hint, as per FIGS. 3A-B and 4A-B respectively, or in parallel, as per FIGS. 5A-C). If there is a hit in one of the local disunited caches, LSCache and LPCache, then as indicated by block 604, there is no change in coherency states for the cache entry related to the desired information. If, on the other hand, there is a miss, the operational flow proceeds to decision block 606, where remote caches are searched, starting with an RSCache. If there is a miss in block 606, the read request is forwarded to one or more RPCaches in block 608. If, on the other hand, there is a hit, two separate possibilities arise, leading to branches following blocks 632, where only one copy of the desired information exists in RSCache, in a M state, and block 640, where multiple copies exist in a S state.

Proceeding first down block 608, in decision block 610, it is determined whether any RPCache contains the desired information. If none of the RPCaches produce a hit, then in block 612, a copy of the desired information is retrieved from main memory, following which, the retrieved information is stored in the LPCache of the requesting local processor in a Valid (V) state, in block 616.

If, on the other hand, in decision block 610, it is determined that the desired information is available in one of the RPCaches, then the operational flow proceeds to decision block 614, where it is determined whether the desired information is in a Valid (V) or Dirty (D) state. If it is in V state, then, in block 618, the desired information is moved into the corresponding remote shared caches RSCache, and the information is placed on a bus in block 620 to transfer the information to the LSCache of the requesting processor. In block 622, the coherency state for shared cache entries containing the desired information are set to S. If in block 614, the copy of the desired information is determined to be in D state, then in block 624, once again, the copy of the information is moved into the corresponding remote shared cache RSCache and the information is placed on a bus to transfer the copy of the information to the local shared cache, LSCache of the requesting processor in block 626. However, in this case, a write back of the copy of the information is also performed to main memory in block 628, since the information is dirty, and the state of shared cache entries containing the desired information are changed from D to S.

Where RSCache is determined to have one copy of the desired information in M state, in block 606, the operational flow proceeds to block 632, where the modified information is placed on a bus in order to perform a write back of the modified information to main memory in block 634. Correspondingly, the states of shared cache entries containing the modified information are changed from M to S in block 636. Following this, the information is stored to the LSCache of the requesting local processor for the desired information, in block 638.

Proceeding down block 640, when decision block 606 reveals that multiple copies of the desired information are available in RSCaches in S state, then in block 640, a copy of the information from a random/arbitrary one of the RSCaches is put on the bus in order to transfer the copy to the LSCache of the requesting local processor, in block 642.

With reference now to FIGS. 7A-B, a write or store operation for desired information, for example based on a request which originates from a requesting local processor as in the multiprocessor system described in FIG. 6, is illustrated. The write operation may be based on no hints being available. In decision block 702, the local private-information cache LPCache of the requesting local processor can be checked. If an entry corresponding to the desired information is already present within the LPCache, in decision block 704, a determination is made whether the desired information is in a Dirty (D) state or a Valid (V) state. If the cache entry is in D state or dirty, the cache entry is updated with the information to be written in block 706. If the cache entry is in V or valid state, the cache entry is updated with the information to be written in block 708 and the state of the cache entry is changed from V to D in block 710.

If, on the other hand, LPCache 702 does not hold a cache entry pertaining to the information to be written, the operational flow proceeds to decision block 712 from block 702. In block 712, the desired information is searched in the shared caches, starting with the local shared cache, LSCache. If the local shared cache LSCache generates a miss, then the operation proceeds to block 726, which is illustrated in FIG. 7B. If there is a hit in the LSCache, then in decision block 714, it is determined whether the corresponding cache entry is in M or S state. If it is in S state, it means that the desired information will be written to only the LSCache by the requesting local processor, which will change the state of shared copies in the remote shared caches. Therefore an update is broadcast to all the RSCaches in block 716 to indicate that the state has been modified, and in block 718 the state is modified from S to I on all the RSCaches which hold a copy of the desired information. In block 720, the cache entry in the LSCache is updated with the desired information to be written by the requesting local processor and in block 722 the state of the cache entry is changed from S to M. On the other hand, if the state of the cache entry in decision block 714 is determined to be M, then in block 724, the cache entry in LSCache is simply updated with the desired information to be written, without requiring any further broadcasts or state updates.

Moving on to FIG. 7B, in decision block 726, it is determined whether a cache entry corresponding to the desired information is present in any of the remote shared caches, RSCaches. If it is present, in at least one RSCache, then in decision block 746, it is determined whether the state of the cache entry in that RSCache is M or S. If the state is M, then in block 750, the corresponding cache entry is written back to the main memory, and the state of the cache entry is changed from M to I in block 752. In block 754, the desired information is then written to the local private cache of the requesting local processor, LPCache. If, on the other hand, in decision block 726, the state of the cache entry in the RSCache is S, then in block 748, the state is directly modified to I and in block 756, the desired information is then written to the local private cache of the requesting local processor, LPCache.

On the other hand, if decision block 726 reveals that none of the RSCaches hold the desired information, then in decision block 728 it is determined whether any of the remote private caches, RPCaches generate a hit. If they do not, in block 730, the desired information is retrieved from main memory and the desired information is stored in the local private cache, LPCache of the requesting local processor in block 732. On the other hand, if one of the RPCaches holds the desired information, then in decision block 734 it is determined whether the state of the desired information is Valid (V) or Dirty (D). If the state is V, then in block 742, the state is invalidated or set to dirty (D) and in block 744, the desired information is stored in the LPCache of the requesting local processor. On the other hand, if the state is already dirty (D), then the desired information is written back to main memory in block 736 and in block 740, the information is stored in the LPCache of the requesting local processor.

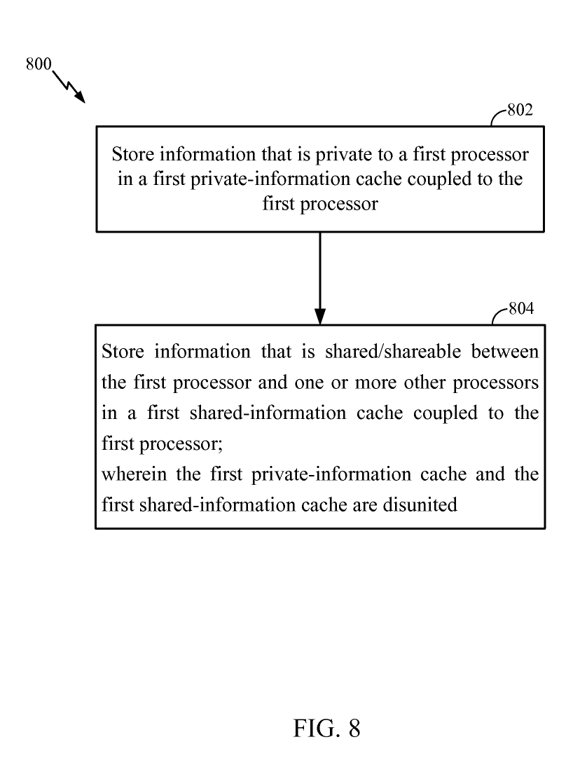

It will be appreciated that exemplary aspects include various methods for performing the processes, functions and/or algorithms disclosed herein. For example, as illustrated in FIG. 8, an exemplary aspect can include a method (800) of operating a multiprocessor system (e.g. multiprocessor system 200). The method can include storing information that is private to a first processor (e.g., processor 202) in a first private-information cache (e.g., private-information L2 cache 206p) coupled to the first processor—Block 802. The method can further include storing information that is shared/shareable between the first processor and one or more other processors (e.g., processor 204) in a first shared-information cache (e.g., private-information L2 cache 206p) coupled to the first processor—Block 804, wherein, the first private-information cache and the first shared-information cache are disunited.

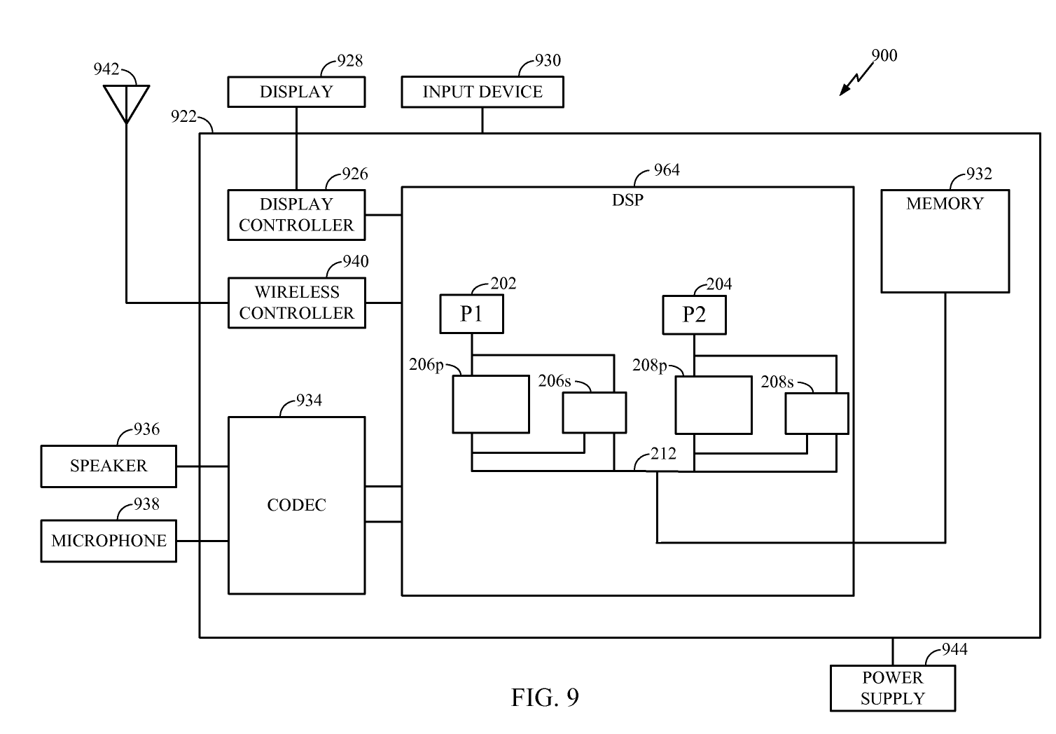

Referring now to FIG. 9, a block diagram of a particular illustrative embodiment of a wireless device that includes a multi-core processor configured according to exemplary embodiments is depicted and generally designated 900. Wireless device 900 includes digital signal processor (DSP) 964, which may include multiple processors with disunited caches according to aspects of this disclosure. More specifically, DSP 964 may include local and remote processors, such as, processors 202 and 204 of multiprocessor system 200 of FIG. 2. According to exemplary aspects, local disunited private-information L2 cache 206p and shared-information L2 cache 206s may be communicatively coupled to local processor 202 and similarly, remote disunited private-information L2 cache 208p and shared-information L2 cache 208s may be communicatively coupled to remote processor 204. The local disunited private-information L2 cache 206p and shared-information L2 cache 206s and remote disunited private-information L2 cache 208p and shared-information L2 cache 208s may be further coupled to one or more higher levels of caches (not shown), and to memory 932 through system bus 212.

FIG. 9 also shows display controller 926 that is coupled to DSP 964 and to display 928. Coder/decoder (CODEC) 934 (e.g., an audio and/or voice CODEC) can be coupled to DSP 964. Other components, such as wireless controller 940 (which may include a modem) are also illustrated. Speaker 936 and microphone 938 can be coupled to CODEC 934. FIG. 9 also indicates that wireless controller 940 can be coupled to wireless antenna 942. In a particular embodiment, DSP 964, display controller 926, memory 932, CODEC 934, and wireless controller 940 are included in a system-in-package or system-on-chip device 922.

In a particular embodiment, input device 930 and power supply 944 are coupled to the system-on-chip device 922. Moreover, in a particular embodiment, as illustrated in FIG. 9, display 928, input device 930, speaker 936, microphone 938, wireless antenna 942, and power supply 944 are external to the system-on-chip device 922. However, each of display 928, input device 930, speaker 936, microphone 938, wireless antenna 942, and power supply 944 can be coupled to a component of the system-on-chip device 922, such as an interface or a controller.

It should be noted that although FIG. 9 depicts a wireless communications device, DSP 964 and memory 932 may also be integrated into a set-top box, a music player, a video player, an entertainment unit, a navigation device, a personal digital assistant (PDA), a fixed location data unit, or a computer.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for operating a multiprocessing system with disunited private-information and shared-information caches. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a multiprocessor system, the method comprising:
storing information that is private to a first processor in a first private-information cache coupled to the first processor; and
storing information that is shared/shareable between the first processor and one or more other processors in a first shared-information cache coupled to the first processor;
wherein the first private-information cache and the first shared-information cache are disunited.

2. The method of claim 1 comprising excluding the shared/shareable information from being stored in the private-information cache.

3. The method of claim 1, wherein a number of entries or size of the first private-information cache is larger than a number of entries or size of the first shared-information cache.

4. The method of claim 1, wherein the first private-information cache does not comprise coherence tracking mechanisms, and the first shared-information cache comprises coherence tracking mechanisms for maintaining coherence of shared/shareable information stored in the shared-information cache.

5. The method of claim 1, wherein, for memory access of a first information, determining that a hint is not available to indicate whether the first information is private or shared/shareable, and sequentially accessing the first private-information cache and then the first shared-information cache.

6. The method of claim 5, further comprising determining a miss for the first information in the first private-information cache and the first shared-information cache then sequentially accessing a second shared-information cache coupled to a second processor at a remote location, and then a second private-information cache coupled to the second processor at the remote location.

7. The method of claim 1, wherein, for memory access of a first information, determining that a hint is not available to indicate whether the first information is private or shared/shareable, and sequentially accessing the first shared-information cache and then the first private-information cache.

8. The method of claim 1, wherein, for memory access of a first information, determining that a hint is not available to indicate whether the first information is private or shared/shareable, and accessing the first private-information cache and the first shared-information cache in parallel.

9. The method of claim 1, wherein, for memory access of a first information, determining that a hint is available to indicate whether the first information is private or shared/shareable, and directing access to the first private-information cache or the first shared-information cache, based on whether the first information is private or shared/shareable respectively.

10. The method of claim 9, further comprising, determining a miss for the first information in the first shared-information cache and accessing a second shared-information cache coupled to a second processor at a remote location.

11. The method of claim 9, comprising deriving the hint from one of a shareability attribute for a region of memory comprising the first information, a compiler, or an operating system.

12. The method of claim 1, further comprising, selectively disabling the first private-information cache to conserve power, when the first processor is not processing instructions, turned off, or in low power or sleep mode.

13. The method of claim 1, wherein one or more of associativity, layout, and replacement policy of each of the two caches, the first private-information cache and the first shared-information cache, are customized based on one or more of coherence tracking requirements, access times, sharing patterns, power considerations, or any combination thereof, of each of the two caches.

14. The method of claim 1, wherein the first private-information cache and the first shared-information cache are level 2 (L2) caches or higher level caches.

15. A multiprocessor system comprising:
a first processor;
a first private-information cache coupled to the first processor, the first private-information cache configured to store information that is private to the first processor; and
a first shared-information cache coupled to the first processor, the first shared-information cache configured to store information that is shared/shareable between the first processor and one or more other processors;
wherein the first private-information cache and the first shared-information cache are disunited.

16. The multiprocessor system of claim 15 wherein the shared/shareable information is excluded from the private-information cache.

17. The multiprocessor system of claim 15, wherein a number of entries or size of the first private-information cache is larger than a number of entries or size of the first shared-information cache.

18. The multiprocessor system of claim 15, wherein the first private-information cache does not comprise coherence tracking mechanisms, and the first shared-information cache comprises coherence tracking mechanisms for maintaining coherence of shared/shareable information stored in the shared-information cache.

19. The multiprocessor system of claim 15, wherein, for memory access of a first information, if a hint is not available to indicate whether the first information is private or shared/shareable, the first processor is configured to access the first private-information cache first and then the first shared-information cache for the first information.

20. The multiprocessor system of claim 19, wherein if a miss is encountered for the first information in the first private-information cache and the first shared-information cache, the first processor is configured to sequentially access a second shared-information cache coupled to a second processor at a remote location, and then a second private-information cache coupled to the second processor at the remote location for the first information.

21. The multiprocessor system of claim 15, wherein, for memory access of a first information, if a hint is available to indicate whether the first information is private or shared/shareable, the first processor is configured to direct access to the first private-information cache or the first shared-information cache for the first information, based on whether the first information is private or shared/shareable respectively.

22. The multiprocessor system of claim 21, wherein the first processor is configured to derive the hint from one of a shareability attribute for a region of memory comprising the first information, a compiler, or an operating system.

23. The multiprocessor system of claim 15, wherein the first private-information cache is physically located close to the first processor and the first shared-information cache is physically located close to a system bus.

24. The multiprocessor system of claim 15, wherein the first private-information cache is configured to be selectively disabled to conserve power, when the first processor is not processing instructions, turned off, or in low power or sleep mode.

25. The multiprocessor system of claim 15, wherein the first private-information cache and the first shared-information cache are level 2 (L2) caches or higher level caches.

26. A multiprocessor system comprising:
a first processor;
first means for storing information that is private to the first processor, the first means coupled to the first processor; and
second means for storing information that is shared/shareable between the first processor and one or more other processors, the second means coupled to the first processor;
wherein the first means and the second means are disunited.

27. A non-transitory computer-readable storage medium comprising code, which, when executed by a first processor of a multiprocessor system, causes the first processor to perform operations for storing information, the non-transitory computer-readable storage medium comprising:
code for storing information that is private to the first processor in a private-information cache coupled to the first processor; and
code for storing information that is shared/shareable between the first processor and one or more other processors in a first shared-information cache coupled to the first processor;
wherein the first private-information cache and the first shared-information cache are disunited.
